(19) United States
(12) Patent Application Publication
(10) Pub. No.: US 2005/0034130 A1
(43) Pub. Date: Feb. 10, 2005

(54) Balancing workload of a grid computing environment

(75) Inventor: Joseph F. Skovira, Owego, NY (US)

Correspondence Address: HESLIN ROTHENBERG FARLEY & MESITI P.C., 5 COLUMBIA CIRCLE, ALBANY, NY, 12203, US

(73) Assignee: International Business Machines Corporation, Armonk, NY (US)

(21) Appl. No.: 10/634,693

(22) Filed: Aug. 5, 2003

(51) Int. Cl. G06F 9/46

(52) U.S. Cl. 718/105

(57) ABSTRACT

Balancing the workload of a grid computing environment. A manager daemon obtains information from a plurality of schedulers of a plurality of systems of the grid computing environment and uses that information to balance the workload of the environment. The information includes an indication of free resources, idle jobs, and possibly other information.

### TECHNICAL FIELD

This invention relates, in general, to grid computing, and in particular, to managing the workload of a grid computing environment.

### BACKGROUND OF THE INVENTION

A grid computing environment allows the interconnection of a plurality of heterogeneous and/or geographically distant systems. To facilitate interconnecting the systems, in one example, a Globus toolkit offered by International Business Machines Corporation, Armonk, N.Y., is employed. Globus allows a user to specify which system of the plurality of systems is to run a job. The user submits a job to the selected system using a Resource Specification Language (RSL). In response to Globus receiving the RSL, Globus converts the RSL into a correct format for the scheduler on the target system. For example, if the scheduler is LoadLeveler offered by International Business Machines Corporation, then the RSL is converted into a command file.

Since users can select the one or more systems to run their jobs or despite the selections, the systems of a grid computing environment can become unbalanced. For instance, one system may have too much work, while another system may have too little. Thus, a need exists for a capability to balance the workload of a grid computing environment. A further need exists for a capability for determining the best fit for particular work.

### SUMMARY OF THE INVENTION

The shortcomings of the prior art are overcome and additional advantages are provided through the provision of a method of balancing workload of a computing environment. The method includes, for instance, obtaining information regarding one or more systems of a plurality of systems of a grid computing environment; and balancing workload of at least two systems of the plurality of systems using at least a portion of the obtained information.

System and computer program products corresponding to the above-summarized method are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one embodiment of a computing environment incorporating and using one or more aspects of the present invention;

FIG. 2 depicts one embodiment of the logic associated with balancing workload of the computing environment of FIG. 1, in accordance with an aspect of the present invention;

FIG. 3 depicts further details regarding one embodiment of the logic associated with workload balancing, in accordance with an aspect of the present invention; and

FIG. 4 depicts one embodiment of the logic used to determine which system of the environment is to run a given job, in accordance with an aspect of the present invention.

### BEST MODE FOR CARRYING OUT THE INVENTION

In accordance with an aspect of the present invention, workload balancing is performed in a grid computing environment. In one example, a manager daemon of the grid computing environment obtains information regarding one or more systems of the environment, and determines based on the obtained information placement of workload on those systems. The placement of workload can include, for instance, moving a job from one system to another or initially placing a job on a particular system, etc. As one example, the information is obtained from schedulers of the systems.

Grid computing enables the virtualization of distributed computing and data resources such as processing, network bandwidth and storage capacity to create a single system image, granting users and applications seamless access to vast information technology (IT) capabilities. Often, the systems of a grid computing environment are heterogeneous systems. That is, at least one system of the plurality of systems of the environment includes different hardware and/or software from at least one other system of the environment. Additionally or alternatively, the systems may be geographically distant from one another. Further details regarding grid computing may be found, for instance, at www-1.ibm.com/grid/about_grid/what_is.shtml.

One embodiment of a grid computing environment incorporating and using one or more aspects of the present invention is depicted in FIG. 1. A grid computing environment 100 includes, for instance, a plurality of systems 102. In this particular example, two systems, System A and System B, are depicted. However, in other examples, more than two systems are included in the computing environment. In one example, System A includes a Scalable Parallel (SP) machine having a plurality of RS/6000 nodes, which is offered by International Business Machines Corporation, Armonk, N.Y., and System B includes a LINUX cluster also offered by International Business Machines Corporation. Systems 102 are coupled to one another via a connection 104, such as, for instance, an Ethernet connection or other type of connection.

System 102 includes, for instance, a scheduler 106 used in scheduling jobs on the system. A scheduler can be one of many types of schedulers and each system may have the same type of scheduler or different type of scheduler. As one example, scheduler 106 of System A includes LoadLeveler offered by International Business Machines Corporation, and scheduler 106 of System B includes the Portable Batch System (PBS) offered by Altair Grid Technologies, LLC. One example of LoadLeveler is described in an IBM publication entitled, “IBM LoadLeveler: Using and Administering,” V3R1, IBM Pub. No. SA22-7881-00, December 2001, which is hereby incorporated herein by reference in its entirety.

In one example, at least one scheduler performs backfill scheduling. Backfill scheduling allows an application to run out of order as long as it does not affect the start time of an application already scheduled to execute. One example of backfill scheduling is described in U.S. patent application Ser. No. 10/406,985 entitled “Backfill Scheduling Of Applications Based On Data Of The Applications,” filed Apr. 4, 2003, which is hereby incorporated herein by reference in its entirety.

Since, in one example, the systems of the grid computing environment are heterogeneous, a toolkit, offered by International Business Machines Corporation and referred to as Globus, is used to facilitate communication between the systems. The toolkit creates a common layer between the systems. For instance, for a Globus enabled system, information for a job passes through Globus, Globus converts it to a Globus format, passes the information to another Globus system, which then converts the information into a form known by the receiving system. This allows systems having one or more of different operating systems, different middleware and/or different schedulers to effectively communicate. Further details regarding Globus can be found, for instance, in “Enabling Applications for Grid Computing with Globus,” IBM publication no. SG24-6936-00, Jun. 18, 2003, which is hereby incorporated herein by reference in its entirety.

In accordance with an aspect of the present invention, one of the systems in the grid computing environment also includes a manager daemon 108. The manager daemon runs in the background and is responsible for balancing the workload among at least a portion of the systems of the environment. The manager daemon obtains (e.g., is provided, determines, etc.) information regarding a plurality of systems to be managed. This information includes, for instance, identification of the systems, manner in which to contact the systems, etc.

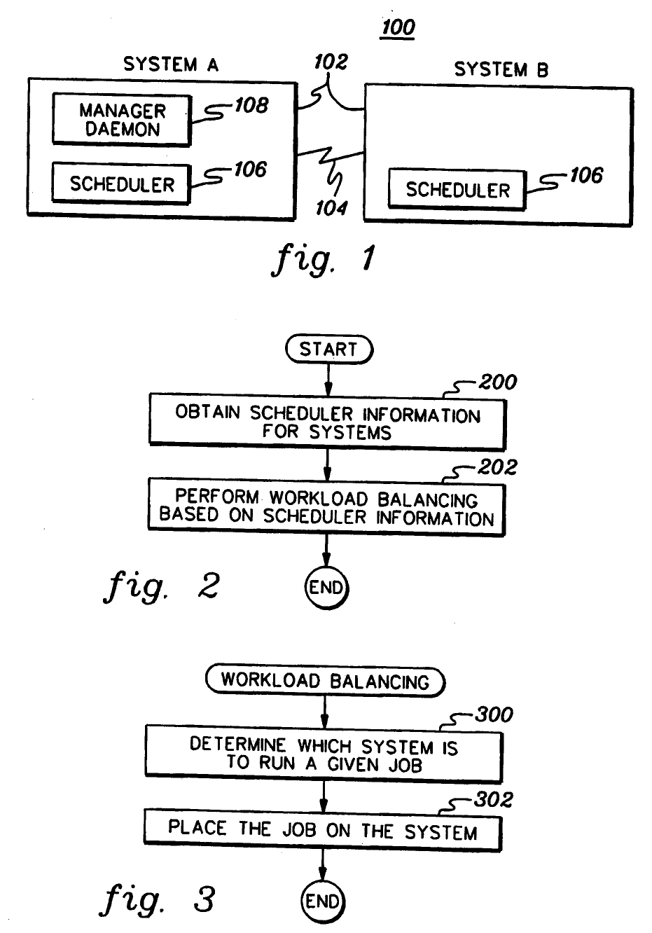

The manager daemon periodically executes logic to balance the workload of a grid computing environment. In one example, this logic is executed at configurable time intervals (e.g., every 5 minutes). As another example, execution of the logic is event based (e.g., upon startup and/or completion of a job, change in available system resources, etc.). One embodiment of the logic associated with balancing the workload of a grid computing environment is described with reference to FIGS. 2-4.

Referring initially to FIG. 2, the manager daemon obtains scheduler information for one or more systems, STEP 200. For instance, the manager daemon contacts the schedulers of those systems to obtain desired information. This information includes, for instance, the current free nodes of the system, the job queue of waiting jobs for that system, and scheduler specific variable settings for the current state of the system job mix, such as a shadow time for the next waiting job (i.e., how long does the job need to wait for resources) and one or more resources protected by the shadow time.

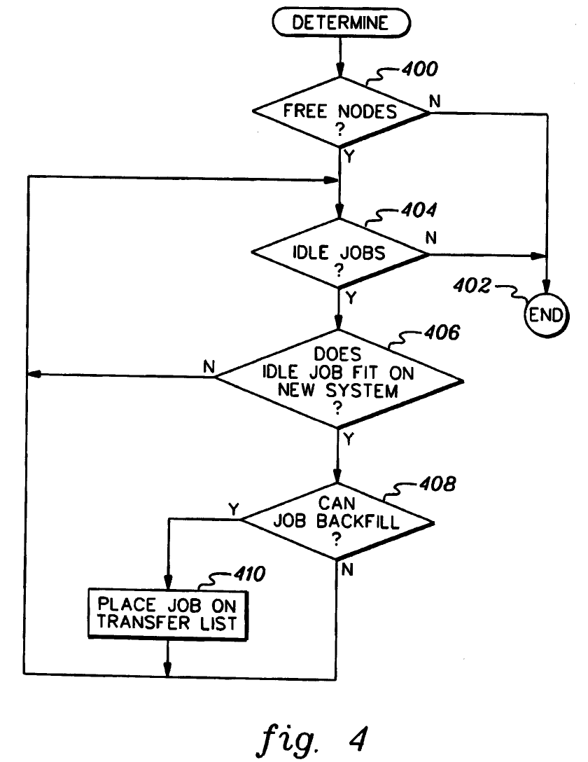

Based on the information obtained, the manager daemon performs workload balancing, STEP 202. Further details regarding one example of workload balancing is described with reference to FIG. 3. Initially, the scheduling information is used to determine which system is to run a given job, STEP 300. In one example, this includes determining which idle jobs on a particular system might run on another system. One example of the logic employed to make this determination is described with reference to FIG. 4. In the example described herein, a determination is made as to whether one or more jobs on System A can be moved to System B. However, it will be apparent to those skilled in the art that similar logic is used to move jobs to System A or to other systems being managed.

Referring to FIG. 4, a determination is made as to whether there are any free nodes on System B, INQUIRY 400. If there are no free nodes, then processing is complete, STEP 402. However, if there are one or more free nodes, then a further determination is made as to whether there are one or more idle jobs on System A, INQUIRY 404. Should there be an idle job on System A, then a further determination is made as to whether the idle job fits on System B, INQUIRY 406. If the idle job does fit on System B, then, in one example, a further determination is made as to whether the job can backfill, INQUIRY 408. If the job does fit on the new system and can backfill, then the job is placed on a transfer list, STEP 410. Otherwise, a determination is made as whether there are further idle jobs on System A, INQUIRY 404. If not, then processing is complete, STEP 402.

Returning to FIG. 3, in addition to determining which system is to run a given job, workload balancing further includes placing the job on that system, STEP 302. In one example, this includes moving each job (or a portion of the jobs) from the transfer list to the indicated system(s). This includes, for instance, placing the job on hold in the original system (e.g., System A) to prevent the job selected for transfer from starting. The job is then submitted to the new system (e.g., System B). If the move is successful, then the job is cancelled from the first system. By using a technique of hold and then move, further error checking may be provided at the discretion of the designer. In one example, commands provided by Globus are used in the moving.

Described in detail above is one embodiment of the logic associated with using a daemon to perform workload balancing in a grid computing environment. One embodiment of pseudo-code used to perform this workload balancing is presented below:

```
Do forever {
  # Get a current snapshot of the 2 batch systems
  Access LoadLeveler on system A for FreeNodesA, ShadowTimeA, IdleJobsA
  Access LoadLeveler on system B for FreeNodesB, ShadowTimeB, IdleJobsB
  Clear the Transfer Lists A2B and B2A
  # Find out which Idle jobs on system A might run on system B
  if (FreeNodesB) { # if there are any free nodes in system B...
    Foreach (IdleJobsA) { # Then for all the idle jobs on system A...
      If(JobA node requirement <= FreeNodesB) { # if the job fits in system B...
        If (JobA Wallclock time <= ShadowTimeB) { # if the job can backfill...
          Place JobA on the Transfer List A2B
        }
      }
    }
  }
  # Find out which Idle jobs on system B might run on system A
  if(FreeNodesA) { # if there are any free nodes in system A...
    Foreach (IdleJobsB) { # Then for all the idle jobs on system B...
      If (JobB node requirement <= FreeNodesA) { # if the job fits in system A...
        If (JobB Wallclock time <= ShadowTimeA) { # if the job can backfill...
          Place JobB on the Transfer List B2A
        }
      }
    }
  }
  # Move potential jobs from A to B
  foreach (job in the A2B array) {
    Move JobA to SystemB
  }
  # Move potential jobs from B to A
  foreach (job in the B2A array) {
    Move JobB to SystemA
  }
  Sleep for a short time # User configurable, about 30 seconds
} # end of Do forever
# Move Job subroutine which moves a job from one system to another
sub Move JobX to SystemY {
  Place JobX on System Hold
  Submit JobX to SystemY
  Once JobX appears on SystemY {
    Remove JobX from SystemX
  }
} # end of subroutine
```

Described herein is a capability for balancing the workload of a grid computing environment. To balance the workload, in one example, work is moved from one system that is more heavily loaded to another system that is more lightly loaded. In other examples, workloads are balanced in other ways. For example, workload balancing may include initially determining which system is to run a particular job and submitting the job on that system. In that case, users submit jobs into a holding pen, which is visible to the daemon. Although the jobs in the holding pen are visible to the daemon, in this example, they are not visible to the schedulers on the individual systems. The daemon requests information from the schedulers and based on this information determines the best fit for a particular job. The daemon then submits the job to the selected system.

Although the initial submission of jobs is controlled, the systems can still become unbalanced. This imbalance may occur because of unpredictable events during job execution (e.g., job failure which causes the job to complete earlier than expected), which would disrupt previous queuing decisions, etc. Thus, the daemon also executes the above logic, in one example, to maintain workload balance.

The information used in balancing the workload can be different, less and/or in addition to that described above. As examples, job class and/or resource matches (such as memory or software licenses), as well as other information could be used to decide the placement of jobs.

The workload balancing capability of the present invention advantageously enables workload on two or more systems of a grid computing environment to be balanced. Again, although two systems are described herein, more than two systems with independent batch queuing capabilities could be controlled with a single daemon. The logic would be expanded to examine information from the additional systems. Further, although examples of systems are provided above, many other possibilities exist. As one example, the systems are homogeneous, but are geographically distant. Many other variations also exist.

In one aspect, the daemon can be deactivated. When it is deactivated, the users can still submit jobs on a plurality of systems, but automatic load balancing between two grid connected systems does not occur.

Further, although the above example uses a backfill scheduling technique, other scheduling techniques including those that do not backfill may be used. If a technique that does not use backfill is employed, then shadow time may not be included in the collected information. For example, in a FIFO scheduling technique, the daemon determines idle nodes, free jobs, and possibly idle job order, but it does not require shadow time. When deciding to move jobs to a system, the free resources are considered and there is no shadow time test. In a like manner, other batch scheduling techniques can be used in managing workloads.

Further, for those schedulers using backfill, in another embodiment, the list of which resources are protected by shadow time (and which are not) is employed to improve the decision making process. For example, a job can be transferred which has a wallclock estimate greater than the shadow time to nodes which are not protected by shadow time (hence, not limited to backfill timing constraints).

Moreover, although examples of schedulers are provided above, many other schedulers can be used without departing from the spirit of the present invention. Examples of other schedulers include, for instance, the Load Sharing Facility (LSF) offered by Platform Computing, and Maui, offered by the Maui Supercomputing Center.

As a further embodiment, more than one system may include a manager daemon. One may be backup of another and/or multiple daemons may work together to manage the workload of the grid computing environment, etc. Moreover, one or more systems of the environment may not have a scheduler, but instead, are scheduled by other schedulers, etc.

Advantageously, one or more aspects of the present invention enable a grid computing environment to be workload balanced. This increases efficiency and productivity. By being dynamic and automatic, the balancing is transparent to users. By obtaining the information from schedulers and maintaining the scheduling responsibilities with the schedulers, complexity of the manager daemon is minimized. Since the information obtained by the daemon comes from complex scheduling software, the amount of information input to the daemon is reduced. Further, the scheduler can send the results of an already executed algorithm to the daemon and the daemon does not have to perform the complex analysis (such as computation of shadow time, etc.).

Advantageously, one or more aspects of the present invention enable a plurality of parallel machines, in which each machine is independently administered, to combine resources under, for instance, a single Globus implementation.

The present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

1. A method of balancing workload of a computing environment, said method comprising:
obtaining information regarding one or more systems of a plurality of systems of a grid computing environment; and
balancing workload of at least two systems of the plurality of systems using at least a portion of the obtained information.

2. The method of claim 1, wherein the obtaining comprises obtaining by a manager daemon of the grid computing environment the information from one or more schedulers associated with the one or more systems.

3. The method of claim 2, wherein information is obtained from at least two schedulers, and wherein one scheduler of the at least two schedulers is a different scheduler from at least one other scheduler of the at least two schedulers.

4. The method of claim 1, wherein the information comprises information regarding workload of said one or more systems.

5. The method of claim 4, wherein the information for a system includes at least one of a number of free nodes of the system, job queue of zero or more waiting jobs, and one or more scheduler specific variable settings for a current state of the system job mix.

6. The method of claim 1, wherein the balancing includes:
determining which system of said at least two systems a job is to be assigned; and
assigning the job to the determined system.

7. The method of claim 1, wherein the balancing includes:
removing a job from one system of the at least two systems; and
assigning the job to another system of the at least two systems.

8. A system of balancing workload of a computing environment, said system comprising:
means for obtaining information regarding one or more systems of a plurality of systems of a grid computing environment; and
means for balancing workload of at least two systems of the plurality of systems using at least a portion of the obtained information.

9. The system of claim 8, wherein the means for obtaining comprises means for obtaining by a manager daemon of the grid computing environment the information from one or more schedulers associated with the one or more systems.

10. The system of claim 9, wherein information is obtained from at least two schedulers, and wherein one scheduler of the at least two schedulers is a different scheduler from at least one other scheduler of the at least two schedulers.

11. The system of claim 8, wherein the information comprises information regarding workload of said one or more systems.

12. The system of claim 11, wherein the information for a system includes at least one of a number of free nodes of the system, job queue of zero or more waiting jobs, and one or more scheduler specific variable settings for a current state of the system job mix.

13. The system of claim 8, wherein the mean for balancing includes:
means for determining which system of said at least two systems a job is to be assigned; and
means for assigning the job to the determined system.

14. The system of claim 8, wherein the means for balancing includes:
means for removing a job from one system of the at least two systems; and
means for assigning the job to another system of the at least two systems.

15. An article of manufacture comprising:
at least one computer usable medium having computer readable program code logic to balance the workload of a computing environment, the computer readable program code logic comprising:
obtain logic to obtain information regarding one or more systems of a plurality of systems of a grid computing environment; and
balance logic to balance workload of at least two systems of the plurality of systems using at least a portion of the obtained information.

16. The article of manufacture of claim 15, wherein the obtain logic comprises logic to obtain by a manager daemon of the grid computing environment the information from one or more schedulers associated with the one or more systems.

17. The article of manufacture of claim 15, wherein the information comprises information regarding workload of said one or more systems.

18. The article of manufacture of claim 17, wherein the information for a system includes at least one of a number of free nodes of the system, job queue of zero or more waiting jobs, and one or more scheduler specific variable settings for a current state of the system job mix.

19. The article of manufacture of claim 15, wherein the balance logic includes:
determine logic to determine which system of said at least two systems a job is to be assigned; and
assign logic to assign the job to the determined system.

20. The article of manufacture of claim 15, wherein the balance logic includes:
remove logic to remove a job from one system of the at least two systems; and
assign logic to assign the job to another system of the at least two systems.
